(19) United States
(12) Patent Application Publication
(10) Pub. No.: US 2007/0025700 A1
(43) Pub. Date: Feb. 1, 2007

(54) Recording medium, method and apparatus for reproducing data and method and apparatus for recording data

(75) Inventor: Kun Suk Kim, Anyang-si (KR)

Correspondence Address: HARNESS, DICKEY & PIERCE, P.L.C., P.O. BOX 8910, RESTON, VA, 20195, US

(73) Assignee: LG Electronics Inc.

(21) Appl. No.: 11/494,614

(22) Filed: Jul. 28, 2006

Related U.S. Application Data
(60) Provisional application No. 60/703,466, filed on Jul. 29, 2005.
(60) Provisional application No. 60/703,462, filed on Jul. 29, 2005.
(60) Provisional application No. 60/710,144, filed on Aug. 23, 2005.

(30) Foreign Application Priority Data
Apr. 26, 2006 (KR) 10-2006-0037778

(51) Int. Cl. H04N 7/00

(52) U.S. Cl. 386/95

(57) ABSTRACT

In one embodiment, management information for managing reproduction of at least a picture-in-picture presentation path is reproduced. The management information includes luma-keying information on a luma-keying function, and the luma-keying function manages transparency of a secondary video stream. The luma-keying information indicates whether the luma-keying function is applicable to the secondary video stream when the secondary video stream is not scaled to full size. The secondary video stream represents the picture-in-picture presentation path with respect to a primary presentation path represented by a primary video stream. The primary video stream and the secondary video stream are reproduced based on the management information.

### DOMESTIC PRIORITY INFORMATION

This application claims the benefit of the U.S. Provisional Application Nos. 60/703,466, 60/703,462 and 60/710,144 filed Jul. 29, 2005, Jul. 29, 2005 and Aug. 23, 2005, which are all hereby incorporated by reference in their entirety.

### FOREIGN PRIORITY INFORMATION

This application claims the benefit of the Korean Patent Application No. 10-2006-0037778, filed on Apr. 16, 2006, which is hereby incorporated by reference in its entirety.

### BACKGROUND OF THE INVENTION

1. Field of the Invention

The present invention relates to recording and reproducing methods and apparatuses, and a recording medium.

2. Discussion of the Related Art

Optical discs are widely used as a recording medium capable of recording a large amount of data therein. Particularly, high-density optical recording mediums such as a Blu-ray Disc (BD) and a high definition digital versatile disc (HD-DVD) have recently been developed, and are capable of recording and storing large amounts of high-quality video data and high-quality audio data.

Such a high-density optical recording medium, which is based on next-generation recording medium techniques, is considered to be a next-generation optical recording solution capable of storing much more data than conventional DVDs. Development of high-density optical recording mediums is being conducted, together with other digital appliances. Also, an optical recording/reproducing apparatus, to which the standard for high density recording mediums is applied, is under development.

In accordance with the development of high-density recording mediums and optical recording/reproducing apparatuses, it is possible to simultaneously reproduce a plurality of videos. However, there is known no method capable of effectively simultaneously recording or reproducing a plurality of videos. Furthermore, it is difficult to develop a complete optical recording/reproducing apparatus based on high-density recording mediums because there is no completely-established standard for high-density recording mediums.

### SUMMARY OF THE INVENTION

The present invention relates to a method of managing reproduction of at least one picture-in-picture presentation path.

In one embodiment, management information for managing reproduction of at least a picture-in-picture presentation path is reproduced. The management information includes luma-keying information on a luma-keying function, and the luma-keying function manages transparency of a secondary video stream. The luma-keying information indicates whether the luma-keying function is applicable to the secondary video stream when the secondary video stream is not scaled to full size. The secondary video stream represents the picture-in-picture presentation path with respect to a primary presentation path represented by a primary video stream. The primary video stream and the secondary video stream are reproduced based on the management information.

In one embodiment, the luma-keying information indicates a luma-keying threshold value. The primary video stream and the secondary video stream are reproduced such that pixels of the secondary video stream having luminance values less than and equal to the luma-keying threshold are displayed fully transparent if the luma-keying function is applicable to the secondary video data.

In another embodiment, the primary video stream and the secondary video stream step are reproduced such that pixels of the secondary video stream having luminance values greater than and equal to the luma-keying threshold are displayed fully transparent if the luma-keying function is applicable to the secondary video data.

In a further embodiment, the luma-keying information indicates a luma-keying range. The primary video stream and the secondary video stream are reproduced such that pixels of the secondary video stream having luminance values falling within the luma-keying range are displayed fully transparent if the luma-keying function is applicable to the secondary video data.

In one embodiment, the management information includes composition information, and the composition information includes position information indicating a position to display the secondary video stream.

In a further embodiment, the management information includes composition information, and the composition information includes scale information indicating a size to display the secondary video stream.

The present invention also relates to apparatuses for managing reproduction of at least one picture-in-picture presentation path, to methods and apparatuses for recording a data structure for managing reproduction of at least one picture-in-picture presentation path, and to a recording medium having a data structure for managing reproduction of at least one picture-in-picture presentation path.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a schematic view illustrating an exemplary embodiment of the combined use of an optical recording/reproducing apparatus according to an embodiment of the present invention and a peripheral appliance;

FIG. 2 is a schematic diagram illustrating a structure of files recorded in an optical disc as a recording medium according to an embodiment of the present invention;

FIG. 3 is a schematic diagram illustrating a data recording structure of the optical disc as the recording medium according to an embodiment of the present invention;

FIG. 4 is a schematic diagram for understanding a concept of a secondary video according to an embodiment of the present invention;

FIG. 5 is a block diagram illustrating an overall configuration of an optical recording/reproducing apparatus according to an embodiment of the present invention;

FIG. 6 is a block diagram schematically illustrating an exemplary embodiment of a playback system according to an embodiment of the present invention;

FIGS. 7A and 7B are schematic diagrams illustrating an AV decoder model according to an embodiment of the present invention;

FIGS. 8A to 8C are schematic diagrams illustrating secondary video sub path types according to an embodiment of the present invention, respectively;

FIG. 9 is a schematic diagram for conceptual understanding of ‘luma-keying’ according to an embodiment of the present invention;

FIG. 10 is a schematic diagram illustrating an exemplary embodiment of secondary video metadata according to the present invention;

FIG. 11 is a flow chart illustrating an exemplary embodiment of a data reproducing method according to the present invention; and

FIG. 12 is a schematic diagram for conceptually understanding flip of the primary and secondary videos carried out using ‘luma-keying’ in accordance with the present invention.

### DETAILED DESCRIPTION OF EXAMPLE EMBODIMENTS

Reference will now be made in detail to example embodiments of the present invention, which are illustrated in the accompanying drawings. Wherever possible, the same reference numbers will be used throughout the drawings to refer to the same or like parts.

In the following description, example embodiments of the present invention will be described in conjunction with an optical disc as an example recording medium. In particular, a Blu-ray disc (BD) is used as an example recording medium, for the convenience of description. However, it will be appreciated that the technical idea of the present invention is applicable to other recording mediums, for example, HD-DVD, equivalently to the BD.

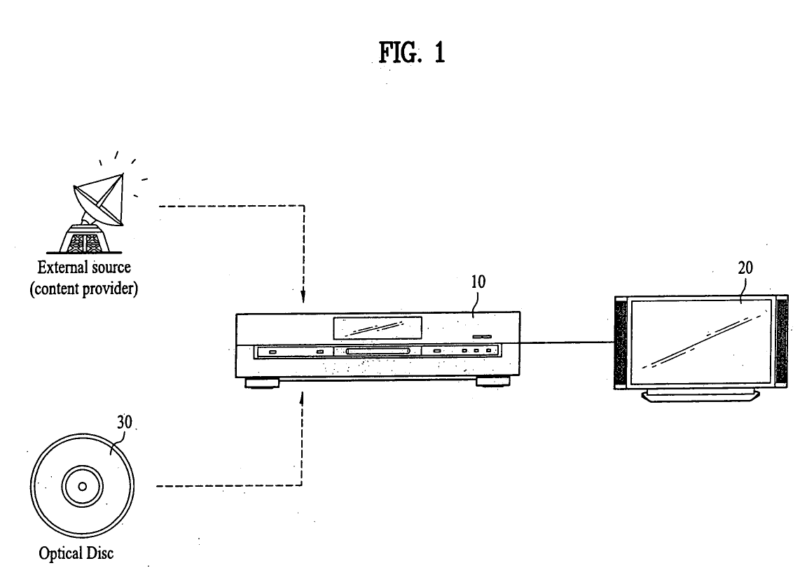

“Storage” as generally used in the embodiments is a storage equipped in a optical recording/reproducing apparatus (FIG. 1). The storage is an element in which the user freely stores required information and data, to subsequently use the information and data. For storages, which are generally used, there are a hard disk, a system memory, a flash memory, and the like. However, the present invention is not limited to such storages.

In association with the present invention, the “storage” is also usable as means for storing data associated with a recording medium (for example, a BD). Generally, the data stored in the storage in association with the recording medium is externally-downloaded data.

As for such data, it will be appreciated that partially-allowed data directly read out from the recording medium, or system data produced in association with recording and production of the recording medium (for example, metadata) can be stored in the storage.

For the convenience of description, in the following description, the data recorded in the recording medium will be referred to as “original data”, whereas the data stored in the storage in association with the recording medium will be referred to as “additional data”.

Also, “title” used in the present invention means a reproduction unit interfaced with the user. Titles are linked with particular objects, respectively. Accordingly, streams recorded in a disc in association with a title are reproduced in accordance with a command or program in an object linked with the title. In particular, for the convenience of description, among the titles recorded in a disc, titles including high-quality video information according to an MPEG-2 compression scheme will be considered. In particular, titles supporting continuous multi-angle, multi-story, credit, director cut, or the like, will be referred to as “High Definition Movie (HDMV) titles”, for the convenience of description. In addition to titles including high-quality video information according to an MPEG compression scheme, titles including Java program information supporting update of titles in a disc and connectability thereof to a network, and thus, providing high interactivity, will be referred to as “BD-J titles”.

FIG. 1 illustrates an exemplary embodiment of the combined use of an optical recording/reproducing apparatus according to the present invention and a peripheral appliance.

The optical recording/reproducing apparatus 10 according to an embodiment of the present invention can record or reproduce data in/from various optical discs having different formats. If necessary, the optical recording/reproducing apparatus 10 may be designed to have recording and reproducing functions only for optical discs of a particular format (for example, BD), or to have a reproducing function alone, except for a recording function. In the following description, however, the optical recording/reproducing apparatus 10 will be described in conjunction with, for example, a BD-player for playback of a BD, or a BD-recorder for recording and playback of a BD, taking into consideration the compatibility of BDs with peripheral appliances, which must be solved in the present invention. It will be appreciated that the optical recording/reproducing apparatus 10 of the present invention may be a drive which can be built in a computer or the like.

The optical recording/reproducing apparatus 10 of the present invention not only has a function for recording and playback of an optical disc 30, but also has a function for receiving an external input signal, processing the received signal, and sending the processed signal to the user in the form of a visible image through an external display 20. Although there is no particular limitation on external input signals, representative external input signals may be digital multimedia broadcasting-based signals, Internet-based signals, etc. Specifically, as to Internet-based signals, desired data on the Internet can be used after being downloaded through the optical recording/reproducing apparatus 10 because the Internet is a medium easily accessible by any person.

In the following description, persons who provide contents as external sources will be collectively referred to as a “content provider (CP)”.

“Content” as used in the present invention may be the content of a title, and in this case means data provided by the author of the associated recording medium.

Hereinafter, original data and additional data will be described in detail. For example, a multiplexed AV stream of a certain title may be recorded in an optical disc as original data of the optical disc. In this case, an audio stream (for example, Korean audio stream) different from the audio stream of the original data (for example, English) may be provided as additional data via the Internet. Some users may desire to download the audio stream (for example, Korean audio stream) corresponding to the additional data from the Internet, to reproduce the downloaded audio stream along with the AV stream corresponding to the original data, or to reproduce the additional data alone. To this end, it is desirable to provide a systematic method capable of determining the relation between the original data and the additional data, and performing management/reproduction of the original data and additional data, based on the results of the determination, at the request of the user.

As described above, for the convenience of description, signals recorded in a disc have been referred to as “original data”, and signals present outside the disc have been referred to as “additional data”. However, the definition of the original data and additional data is only to classify data usable in the present invention in accordance with data acquisition methods. Accordingly, the original data and additional data should not be limited to particular data. Data of any attribute may be used as additional data as long as the data is present outside an optical disc recorded with original data, and has a relation with the original data.

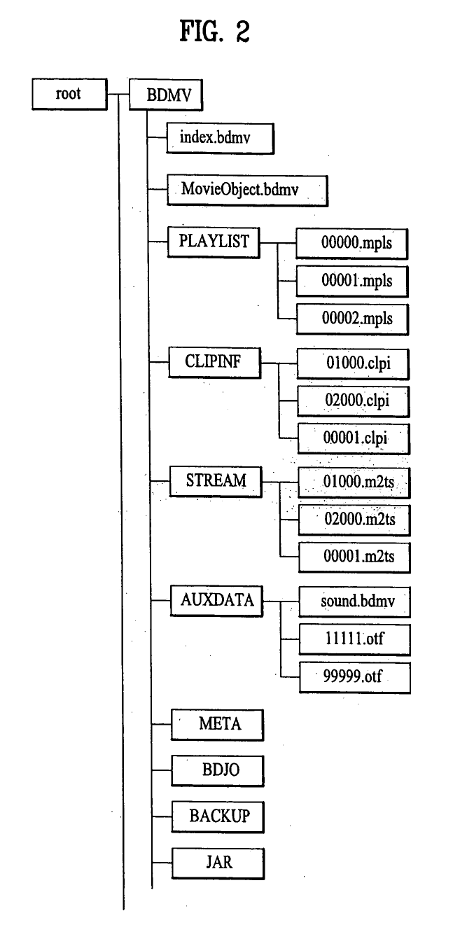

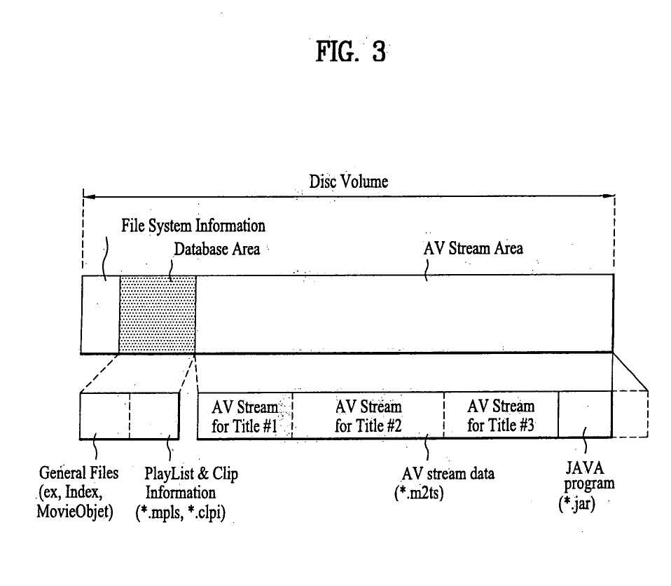

In order to accomplish the request of the user, the original data and additional data must have file structures having a relation therebetween, respectively. Hereinafter, file structures and data recording structures usable in a BD will be described with reference to FIGS. 2 and 3.

FIG. 2 illustrates a file structure for reproduction and management of original data recorded in a BD in accordance with an embodiment of the present invention.

The file structure of the present invention includes a root directory, and at least one BDMV directory BDMV present under the root directory. In the BDMV directory BDMV, there are an index file “index.bdmv” and an object file “MovieObject.bdmv” as general files (upper files) having information for securing an interactivity with the user. The file structure of the present invention also includes directories having information as to the data actually recorded in the disc, and information as to a method for reproducing the recorded data, namely, a playlist directory PLAYLIST, a clip information directory CLIPINF, a stream directory STREAM, an auxiliary directory AUXDATA, a BD-J directory BDJO, a metadata directory META, a backup directory BACKUP, and a JAR directory. Hereinafter, the above-described directories and files included in the directories will be described in detail.

The JAR directory includes JAVA program files.

The metadata directory META includes a file of data about data, namely, a metadata file. Such a metadata file may include a search file and a metadata file for a disc library. Such metadata files are used for efficient search and management of data during the recording and reproduction of data.

The BD-J directory BDJO includes a BD-J object file for reproduction of a BD-J title.

The auxiliary directory AUXDATA includes an additional data file for playback of the disc. For example, the auxiliary directory AUXDATA may include a “Sound.bdmv” file for providing sound data when an interactive graphics function is executed, and “11111.otf” and “99999.otf” files for providing font information during the playback of the disc.

The stream directory STREAM includes a plurality of files of AV streams recorded in the disc according to a particular format. Most generally, such streams are recorded in the form of MPEG-2-based transport packets. The stream directory STREAM uses “*.m2ts” as an extension name of stream files (for example, 01000.m2ts, 02000.m2ts, . . . ). Particularly, a multiplexed stream of video/audio/graphic information is referred to as an “AV stream”. A title is composed of at least one AV stream file.

The clip information (clip-info) directory CLIPINF includes clip-info files 01000.clpi, 02000.clpi, . . . respectively corresponding to the stream files “*.m2ts” included in the stream directory STREAM. Particularly, the clip-info files “*.clpi” are recorded with attribute information and timing information of the stream files “*.m2ts”. Each clip-info file “*.clpi” and the stream file “*.m2ts” corresponding to the clip-info file “*.clpi” are collectively referred to as a “clip”. That is, a clip is indicative of data including both one stream file “*.m2ts” and one clip-info file “*.clpi” corresponding to the stream file “*.m2ts”.

The playlist directory PLAYLIST includes a plurality of playlist files “*.mpls”. “Playlist” means a combination of playing intervals of clips. Each playing interval is referred to as a “playitem”. Each playlist file “*.mpls” includes at least one playitem, and may include at least one subplayitem. Each of the playitems and subplayitems includes information as to the reproduction start time IN-Time and reproduction end time OUT-Time of a particular clip to be reproduced. Accordingly, a playlist may be a combination of playitems.

As to the playlist files, a process for reproducing data using at least one playitem in a playlist file is defined as a “main path”, and a process for reproducing data using one subplayitem is defined as a “sub path”. The main path provides master presentation of the associated playlist, and the sub path provides auxiliary presentation associated with the master presentation. Each playlist file should include one main path. Each playlist file also includes at least one sub path, the number of which is determined depending on the presence or absence of subplayitems. Thus, each playlist file is a basic reproduction/management file unit in the overall reproduction/management file structure for reproduction of a desired clip or clips based on a combination of one or more playitems.

In association with the present invention, video data, which is reproduced through a main path, is referred to as a primary video, whereas video data, which is reproduced through a sub path, is referred to as a secondary video. The function of the optical recording/reproducing apparatus for simultaneously reproducing primary and secondary videos is also referred to as a “picture-in-picture (PiP) function”.

The backup directory BACKUP stores a copy of the files in the above-described file structure, in particular, copies of files recorded with information associated with playback of the disc, for example, a copy of the index file “index.bdmv”, object files “MovieObject.bdmv” and “BD-JObject.bdmv”, unit key files, all playlist files “*.mpls” in the playlist directory PLAYLIST, and all clip-info files “*.clpi” in the clip-info directory CLIPINF. The backup directory BACKUP is adapted to separately store a copy of files for backup purposes, taking into consideration the fact that, when any of the above-described files is damaged or lost, fatal errors may be generated in association with playback of the disc.

Meanwhile, it will be appreciated that the file structure of the present invention is not limited to the above-described names and locations. That is, the above-described directories and files should not be understood through the names and locations thereof, but should be understood through the meaning thereof.

FIG. 3 illustrates a data recording structure of the optical disc according to an embodiment of the present invention. In FIG. 3, recorded structures of information associated with the file structures in the disc are illustrated. Referring to FIG. 3, it can be seen that the disc includes a file system information area recorded with system information for managing the overall file, an area recorded with the index file, object file, playlist files, clip-info files, and meta files (which are required for reproduction of recorded streams “*.m2ts”), a stream area recorded with streams each composed of audio/video/graphic data or STREAM files, and a JAR area recorded with JAVA program files. The areas are arranged in the above-descried order when viewing from the inner periphery of the disc.

In accordance with the present invention, stream data of a primary video and/or a secondary video is stored in the stream area. In the present invention, the secondary video may be multiplexed in the same stream as the primary video, or may be multiplexed in a stream different from that of the primary video.

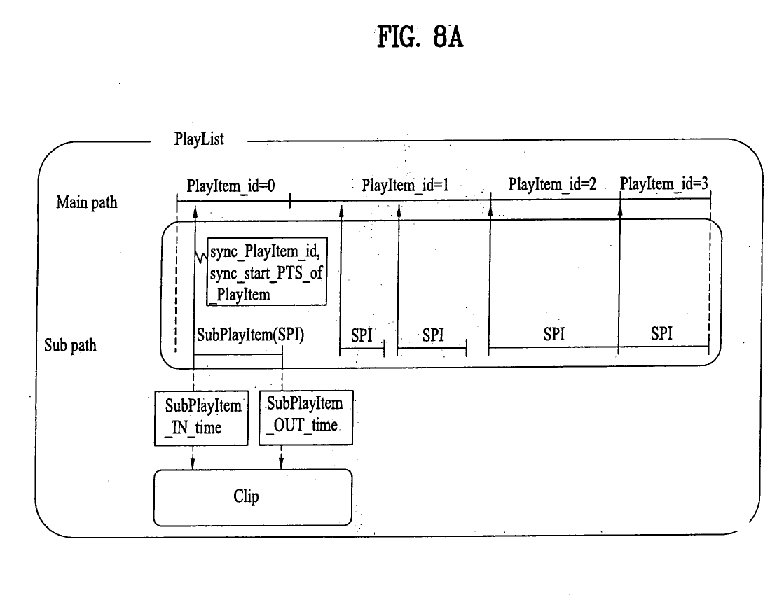

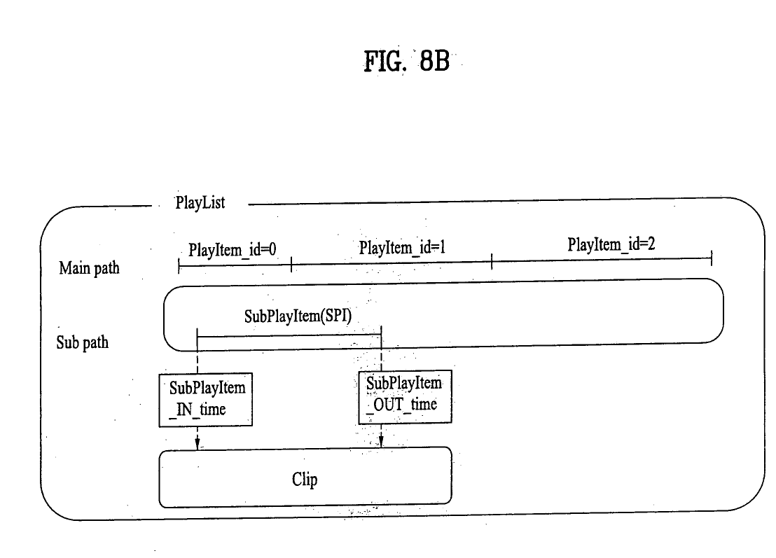

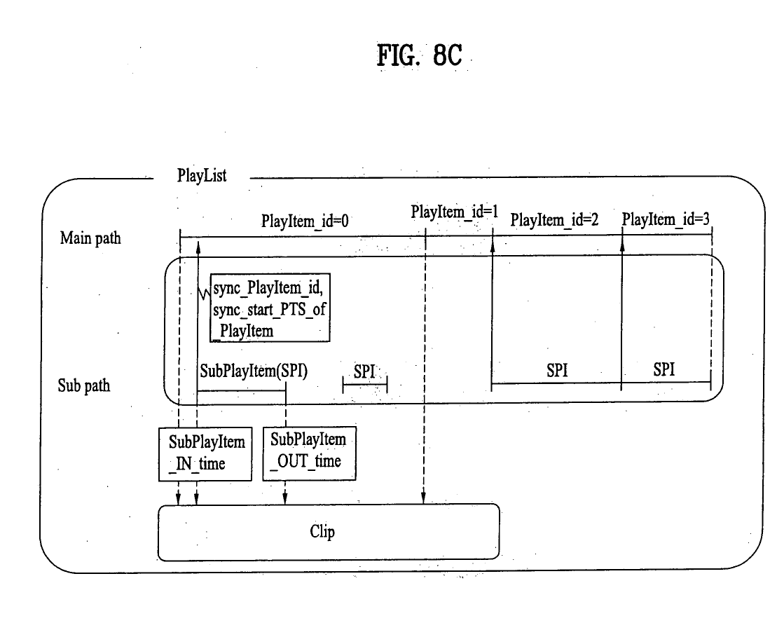

In the disc, there is an area for recording file information for reproduction of contents in the stream area. This area is referred to as a “management area”. The file system information area and database area are included in the management area. In accordance with the present invention, a sub path is used to reproduce the secondary video. The type of the sub path used to reproduce the secondary video may be classified into three types in accordance with the kind of a stream in which the secondary video is multiplexed, and whether or not the sub path is synchronous with a main path. The three sub path types will be described with reference to FIGS. 8A to 8C. Since the method for reproducing the secondary video is varied depending on the sub path type, the management area includes information representing the sub path type.

The areas of FIG. 3 are shown and described only for illustrative purposes. It will be appreciated that the present invention is not limited to the area arrangement of FIG. 3.

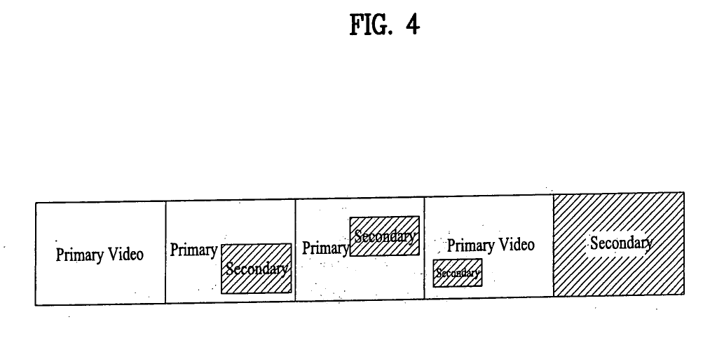

FIG. 4 is a schematic diagram for understanding of the concept of the secondary video according to the present invention.

The present invention has an object to provide a method for reproducing secondary video data, simultaneously with primary video data. That is, the present invention implements an optical recording/reproducing apparatus which enables a PiP application, and, in particular, effectively performs the PiP application.

During reproduction of a primary video as shown in FIG. 4, other video associated with the primary video may be displayed through the same display 20 as that of the primary video. In accordance with the present invention, such a PiP function can be achieved. For example, during reproduction of a movie or documentary, it is possible to provide, to the user, the comments of the director or episode associated with the shooting procedure. In this case, the video of the comments or episode is a secondary video. The secondary video can be reproduced on the primary video.

The secondary video can be reproduced simultaneously with the primary video, from the beginning of the reproduction of the primary video. The reproduction of the secondary video may also be begun at an intermediate time of the reproduction of the primary video. It is also possible to display the secondary video while varying the position or size of the secondary video on the screen, depending on the reproduction procedure. Also, when, for example, the secondary video is not scaled to full size, it is possible to selectively control the transparency of the secondary video. A plurality of secondary videos may also be implemented. In this case, the secondary videos may be reproduced, separately from one another, during the reproduction of the primary video. The primary video can be reproduced along with an audio associated with the primary video. Similarly, the secondary video can be reproduced along with an audio associated with the secondary video.

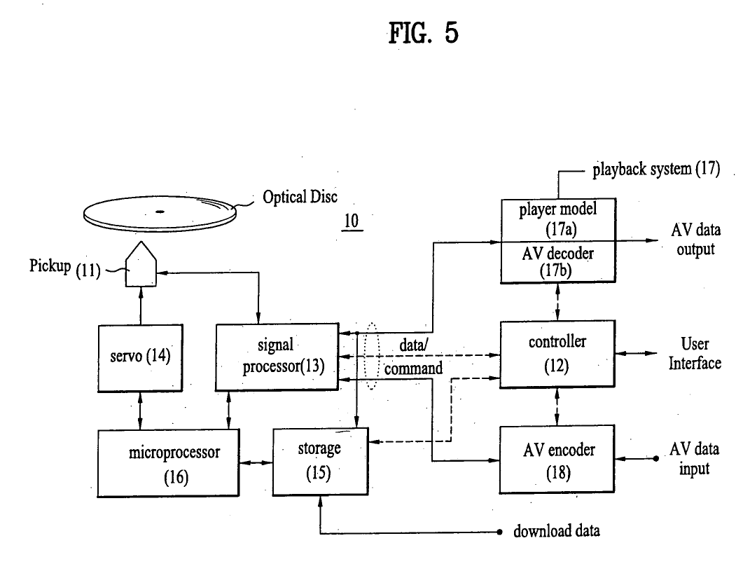

FIG. 5 illustrates an exemplary embodiment of the overall configuration of the optical recording/reproducing apparatus 10 according to the present invention.

As shown in FIG. 5, the optical recording/reproducing apparatus 10 mainly includes a pickup 11, a servo 14, a signal processor 13, and a microprocessor 16. The pickup 11 reproduces original data and management data recorded in an optical disc. The management data includes reproduction management file information. The servo 14 controls operation of the pickup 11. The signal processor 13 receives a reproduced signal from the pickup 11, and restores the received reproduced signal to a desired signal value. The signal processor 13 also modulates signals to be recorded, for example, primary and secondary videos, to signals recordable in the optical disc, respectively. The microprocessor 16 controls the operations of the pickup 11, the servo 14, and the signal processor 13. The pickup 11, the servo 14, the signal processor 13, and the microprocessor 16 are also collectively referred to as a “recording/reproducing unit”. In accordance with the present invention, the recording/reproducing unit reads data from an optical disc 30 or storage 15 under the control of a controller 12, and sends the read data to an AV decoder 17b. That is, in a viewpoint of reproduction, the recording/reproducing unit functions as a reader unit for reading data. The recording/reproducing unit also receives an encoded signal from an AV encoder 18, and records the received signal in the optical disc 30. Thus, the recording/reproducing unit can record video and audio data in the optical disc 30.

The controller 12 downloads additional data present outside the optical disc 30 in accordance with a user command, and stores the additional data in the storage 15. The controller 12 also reproduces the additional data stored in the storage 15 and/or the original data in the optical disc 30 at the request of the user. In accordance with the present invention, the controller 12 produces metadata for managing reproduction of the secondary video, and performs a control operation for recording the metadata in the optical disc 30, along with video data.

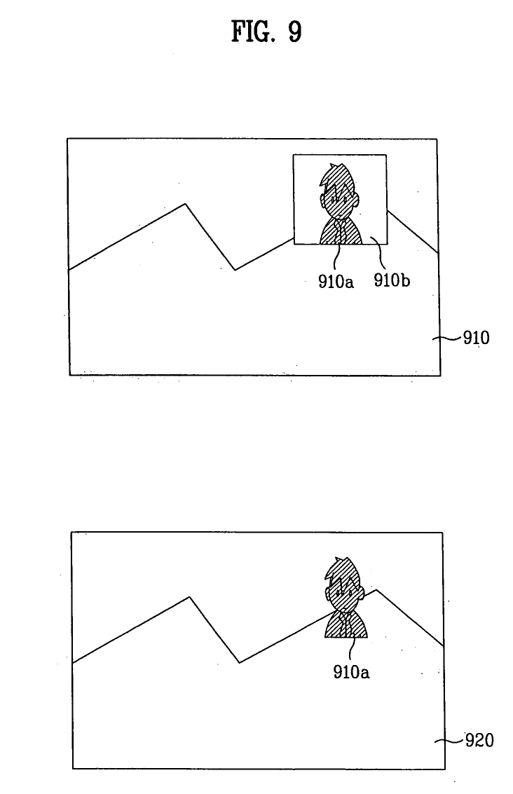

In this connection, in accordance with the present invention the metadata may include information as to whether or not luma-keying should be applied to the secondary video. The metadata also include information for specifying pixels to be transparency-processed. This will be described in detail with reference to FIG. 9.

The optical recording/reproducing apparatus 10 further includes a playback system 17 for finally decoding data, and providing the decoded data to the user under the control of the controller 12. The playback system 17 includes an AV decoder 17b for decoding an AV signal. The playback system 17 also includes a player model 17a for analyzing an object command or application associated with playback of a particular title, for analyzing a user command input via the controller 12, and for determining a playback direction, based on the results of the analysis. In an embodiment, the player model 17a may be implemented as including the AV decoder 17a. In this case, the playback system 17 is the player model itself. The AV decoder 17b may include a plurality of decoders respectively associated with different kinds of signals.

The AV encoder 18, which is also included in the optical recording/reproducing apparatus 10 of the present invention, converts an input signal to a signal of a particular format, for example, an MPEG2 transport stream, and sends the converted signal to the signal processor 13, to enable recording of the input signal in the optical disc 30.

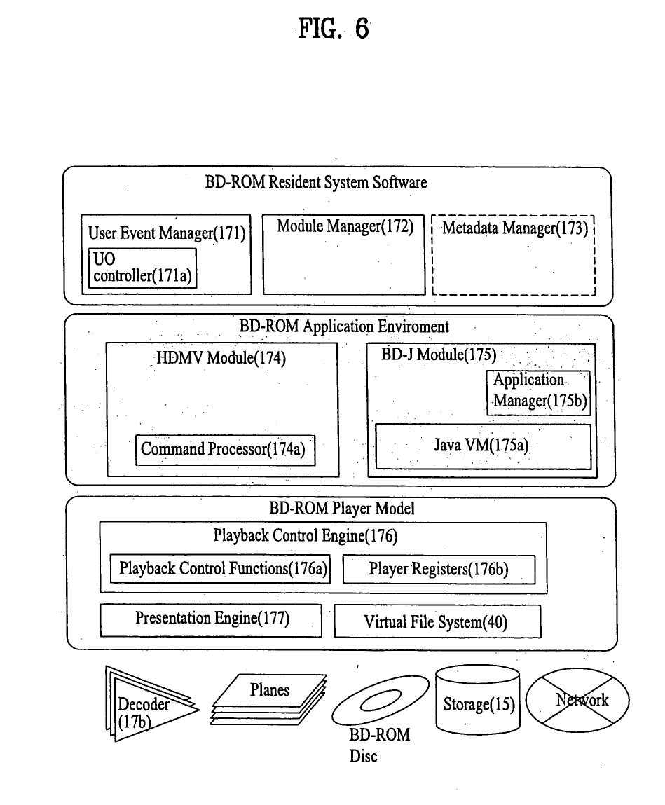

FIG. 6 is a schematic diagram explaining the playback system according to an embodiment of the present invention. In accordance with the present invention, the playback system can simultaneously reproduce the primary and secondary videos.

“Playback system” means a collective reproduction processing means which is configured by programs (software) and/or hardware provided in the optical recording/reproducing apparatus. That is, the playback system is a system which can not only play back a recording medium loaded in the optical recording/reproducing apparatus, but also can reproduce and manage data stored in the storage of the apparatus in association with the recording medium (for example, after being downloaded from the outside of the recording medium).

In particular, as shown in FIG. 6, the playback system 17 may include a user event manager 171, a module manager 172, a metadata manager 173, an HDMV module 174, a BD-J module 175, a playback control engine 176, a presentation engine 177, and a virtual file system 40. This configuration will be described in detail, hereinafter.

As a separate reproduction processing/managing means for reproduction of HDMV titles and BD-J titles, the HDMV module 174 for HDMV titles and the BD-J module 175 for BD-J titles are constructed independently of each other. Each of the HDMV module 174 and BD-J module 175 has a control function for receiving a command or program contained in the associated object “Movie Object” or “BD-J Object”, and processing the received command or program. Each of the HDMV module 174 and BD-J module 175 can separate an associated command or application from the hardware configuration of the playback system, to enable portability of the command or application. For reception and processing of the command, the HDMV module 174 includes a command processor 174a. For reception and processing of the application, the BD-J module 175 includes a Java Virtual Machine (VM) 175a, and an application manager 175b.

The Java VM 175a is a virtual machine in which an application is executed. The application manager 175b includes an application management function for managing the life cycle of an application processed in the BD-J module 175.

The module manager 172 functions not only to send user commands to the HDMV module 174 and BD-J module 175, respectively, but also to control operations of the HDMV module 174 and BD-J module 175. A playback control engine 176 analyzes the playlist file actually recorded in the disc in accordance with a playback command from the HDMV module 174 or BD-J module 175, and performs a playback function based on the results of the analysis. The presentation engine 177 decodes a particular stream managed in association with reproduction thereof by the playback control engine 176, and displays the decoded stream in a displayed picture. In particular, the playback control engine 176 includes playback control functions 176a for managing all playback operations, and player registers 176b for storing information as to the playback status and playback environment of the player (information of player status registers (PSRs) and general purpose registers (GPRs)). In some cases, the playback control functions 176a mean the playback control engine 176 itself.

The HDMV module 174 and BD-J module 175 receive user commands in independent manners, respectively. The user command processing methods of HDMV module 174 and BD-J module 175 are also independent of each other. In order to transfer a user command to an associated one of the HDMV module 174 and BD-J module 175, a separate transfer means should be used. In accordance with the present invention, this function is carried out by the user event manager 171. Accordingly, when the user event manager 171 receives a user command generated through a user operation (UO) controller 171a, the user event manager sends the received user command to the module manager 172 or UO controller 171a. On the other hand, when the user event manager 171 receives a user command generated through a key event, the user event manager sends the received user command to the Java VM 175a in the BD-J module 175.

The playback system 17 of the present invention may also include a metadata manager 173. The metadata manager 173 provides, to the user, a disc library and an enhanced search metadata application. The metadata manager 173 can perform selection of a title under the control of the user. The metadata manager 173 can also provide, to the user, recording medium and title metadata.

The module manager 172, HDMV module 174, BD-J module 175, and playback control engine 176 of the playback system according to the present invention can perform desired processing in a software manner. Practically, the processing using software is advantageous in terms of design, as compared to processing using a hardware configuration. Of course, it is general that the presentation engine 177, decoder 17b, and planes are designed using hardware. In particular, the constituent elements (for example, constituent elements designated by reference numerals 172, 174, 175, and 176), each of which performs desired processing using software, may constitute a part of the controller 12. Therefore, it should be noted that the above-described constituents and configuration of the present invention be understood on the basis of their meanings, and are not limited to their implementation methods such as hardware or software implementation. Here, “plane” means a conceptual model for explaining overlaying procedures of the primary video, secondary video, PG (presentation graphics), IG (interactive graphics), text sub titles. In accordance with the present invention, the secondary video plane is arranged in front of the primary video plane. Accordingly, the secondary video output after being decoded is presented on the secondary video plane.

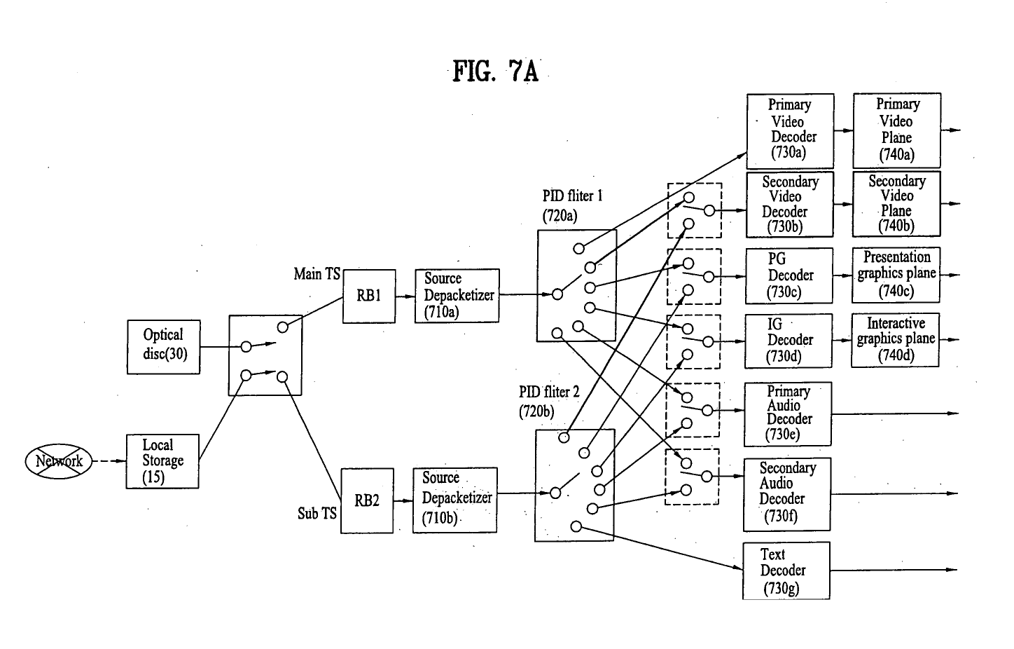

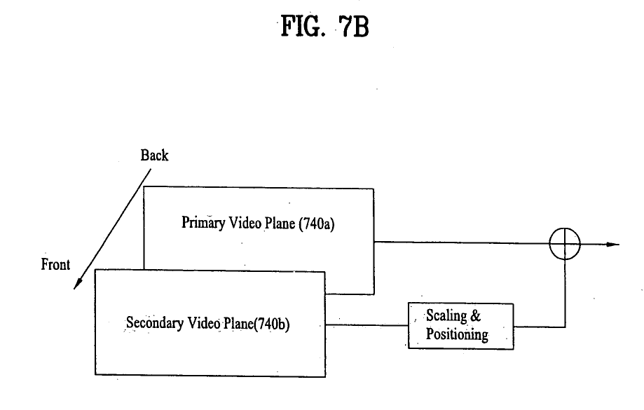

FIGS. 7A and 7B schematically illustrate an AV decoder model according to the present invention.

Referring to FIG. 7A, the AV decoder 17b according to the present invention includes a secondary video decoder 730b for simultaneous reproduction of the primary and secondary videos, namely, implementation of a PiP application. The secondary video decoder 730b decodes the secondary video. The secondary video may be recorded in the recording medium 30 in a state of being contained in an AV stream, to be supplied to the user. The secondary video may also be supplied to the user after being downloaded from the outside of the recording medium 30. The AV stream is supplied to the AV decoder 17b in the form of a transport stream (TS).

In the present invention, the AV stream, which is reproduced through a main path, is referred to as a main transport stream or main TS (hereinafter, also referred to as a “main stream”), and an AV stream other than the main stream is referred to as a sub transport stream or sub TS (hereinafter, also referred to as a “sub stream”).

In the AV decoder 17b, a main stream from the optical disc 30 passes through a switching element to a buffer RB1, and the buffered main stream is depacketized by a source depacketizer 710a. Data contained in the depacketized AV stream is supplied to an associated one of decoders 730a to 730g after being separated from the depacketized AV stream in a PID (packet identifier) filter-1 720a in accordance with the kind of the data packet. That is, in case that a secondary video is contained in the main stream, the secondary video is separated from other data packets in the main stream by the PID filter-1 720a, and is then supplied to the secondary video decoder 730b. As shown, the packets from the PID filter-1 720a may pass through another switching element before receipt by the decoders 730b-730g.

On the other hand, each sub stream from the optical disc 30 or local storage 15 passes through a switching element to a buffer RB2, the buffered sub stream is depacketized by a source depacketizer 710b. Data contained in the depacketized AV stream is supplied to an associated one of the decoders 730a to 730g after being separated from the depacketized AV stream in a PID filter-2 720b in accordance with the kind of the data packet. As shown, the packets from the PID filter-2 720b may pass through another switching element before receipt by the decoders 730b-730f.

That is, the primary video is decoded in a primary video decoder 730a, and the primary audio is decoded in a primary audio decoder 730e. Also, the PG (presentation graphics), IG (interactive graphics), secondary audio, text subtitle are decoded in a PG decoder 730c, an IG decoder 730d, a secondary audio decoder 730f, and a text decoder 730g, respectively.

FIGS. 8A to 8C illustrate secondary video sub path types according to the present invention.

PiP application models according to the present invention are mainly classified into three types, based on the kind of a stream, in which the secondary video is multiplexed, and whether or not the sub path used to reproduce the secondary video is synchronous with a main path associated with the sub path. Accordingly, in the present invention, the kind of the sub path used to reproduce the secondary video, namely, the sub path type, is determined, taking into consideration the above-described three models.

In a sub path type shown in FIG. 8A, the secondary video is encoded in a stream different from that of the primary video, and the sub path is synchronous with the main path. The case in which the secondary video is multiplexed in a stream different from that of the primary video, as described above, is referred to as an ‘out-of-mux’ type.

Referring to FIG. 8A, the playlist for managing the primary and secondary videos includes one main path used to reproduce the primary video, and one sub path used to reproduce the secondary video. The main path is constituted by four playitems (‘PlayItem_id’=0, 1, 2, 3), whereas the sub path is constituted by a plurality of subplayitems. The sub path is synchronous with the main path. In detail, the secondary video is synchronized with the main path, using an information field ‘sync-PlayItem_id’, which identifies a playitem associated with each subplayitem, namely, information, and presentation time stamp information ‘sync start_PTS_of_PlayItem’, which represents a presentation time of the subplayitem in the playitem. That is, when the presentation point of the playitem reaches a value referred to by the presentation time stamp information, the presentation of the associated subplayitem is begun. Thus, reproduction of the secondary video through one sub path is begun at a predetermined time during the reproduction of the primary video through the main path.

In this case, the playitem and subplayitem refer to different clips, respectively, because the secondary video is multiplexed in a stream different from that of the primary video. Each of the playitems and subplayitems includes information as to the reproduction start time IN-Time and reproduction end time OUT-Time of a particular clip to be reproduced. Accordingly, the clip referred to by the associated playitem and subplayitem is supplied to the AV decoder 17b.

Referring to FIG. 7A, the secondary video, which is reproduced through the sub path corresponding to the sub path type of FIG. 8A, is supplied to the AV decoder 17b as a sub stream (Sub TS), whereas the primary video is supplied to the AV decoder 17b as a main stream (Main TS). In the AV decoder 17b, the main stream is depacketized by the source depacketizer 710a, and is then sent to the PID filter-1 720a. On the other hand, the sub stream is depacketized by the source depacketizer 710b, and is then sent to the PID filter-2 720b. Data contained in the depacketized sub stream or main stream is separated from the associated depacketized stream in the associated PID filter-1 720a or PID filter-2 720b in accordance with the kind of the data packet thereof, and is sent to an associated one of decoders 730a to 730g, so as to be decoded. That is, the primary video is decoded in a primary video decoder 730a, and the primary audio is decoded in a primary audio decoder 730e. Also, the PG, IG, secondary audio, text subtitle are decoded in a PG decoder 730c, an IG decoder 730d, a secondary audio decoder 730f, and a text decoder 730g, respectively.

The decoded primary video, secondary video, PG, and IG are reproduced by a primary video plane 740a, a secondary video plane 740b, a presentation graphics plane 740c, and an interactive graphics plane 740d, respectively. The presentation graphics plane 740c can also reproduce graphic data decoded in the text decoder 730g. The decoded primary and secondary audios are output after being mixed in an audio mixer. Since the sub path used to reproduce the secondary video is synchronous with the main path used to reproduce the primary video in the sub path type of FIG. 8A, the controller 12 performs a control operation for outputting the secondary video in synchronization with the primary video.

In a sub path type shown in FIG. 8B, the secondary video is encoded in a stream different from that of the primary video, and the sub path is asynchronous with the main path. Similar to the sub path type of FIG. 8A, secondary video streams, which will be reproduced through sub paths, are multiplexed in a state of being separated from a clip to be reproduced based on the associated playitem. However, the sub path type of FIG. 8B is different from the sub path type of FIG. 8A in that the presentation of the sub path can be begun at any time on the timeline of the main path.

Referring to FIG. 8B, the playlist for managing the primary and secondary videos includes one main path used to reproduce the primary video, and one sub path used to reproduce the secondary video. The main path is constituted by three playitems (‘PlayItem_id’=0, 1, 2), whereas the sub path is constituted by one subplayitem. The secondary video, which is reproduced through the sub path, is asynchronous with the main path. That is, even when the subplayitem includes information for identifying a playitem associated with the subplayitem and presentation time stamp information representing a presentation time of the subplayitem in the playitem, these information are ineffective in the sub path type of FIG. 8B. Accordingly, the optical recording/reproducing apparatus 10 can operate irrespective of the above-described information used to synchronize the main path and sub path. Thus, the user can view the secondary video at any time during the reproduction of the primary video.

In a sub path type shown in FIG. 8C, the secondary video is encoded in the same stream as the primary video, and the sub path is synchronous with the main path. The case in which the secondary video is multiplexed in a stream different from that of the primary video, as described above, is referred to as an ‘out-of-mux’ type. The sub path type of FIG. 8C is different from those of FIGS. 8A and 8B in that the secondary video is multiplexed in the same AV stream as the primary video. The case in which the secondary video is multiplexed in the same stream as the primary video, as described above, is referred to as an ‘in-mux’ type.

Referring to FIG. 8C, the playlist for managing the primary and secondary videos includes one main path and one sub path. The main path is constituted by four playitems (‘PlayItem_id’=0, 1, 2, 3), whereas the sub path is constituted by a plurality of subplayitems. Each of the subplayitems constituting the sub path includes information for identifying a playitem associated with the subplayitem and presentation time stamp information representing a presentation time of the subplayitem in the playitem. As described above with reference to FIG. 8A, each subplayitem is synchronized with the associated playitem, using the above-described information. Thus, the secondary video is synchronized with the primary video.

In the sub path type of FIG. 8C, each of the playitems constituting the main path and an associated one or ones of the subplayitems constituting the sub path refer to the same clip. Accordingly, the secondary video is supplied to the AV decoder 17b, along with the primary video, as a main stream. As shown in FIG. 7A, the main stream, which is packetized data including the primary and secondary videos, is depacketized by the source depacketizer 710a, and is then sent to the PID filter-1 720a. Data packets are separated from the depacketized data in the PID filter-1 720a in accordance with associated PIDs, respectively, and are then sent to associated ones of the decoders 730a to 730g, so as to be decoded. That is, the primary video is output from the primary video decoder 730a after being decoded in the primary video decoder 730a. The secondary video is output from the secondary video decoder 730b after being decoded in the secondary video decoder 730b. In this case, the controller 12 performs a control operation for displaying the secondary video in synchronism with the primary video.

The main stream and sub stream may be supplied from the recording medium 30 or storage 15 to the AV decoder 17b. Where the primary and secondary videos are stored in different clips, respectively, the primary video may be recorded in the recording medium 30, to be supplied to the user, and the secondary video may be downloaded from the outside of the recording medium 30 to the storage 15. Of course, the case opposite to the above-described case may be possible. However, where both the primary and secondary videos are stored in the recording medium 30, one of the primary and secondary videos should be copied to the storage 15, prior to the reproduction thereof, in order to enable the primary and secondary videos to be simultaneously reproduced. Where both the primary and secondary videos are stored in the same clip, they are supplied after being recorded in the recording medium 30. In this case, however, both the primary and secondary videos are downloaded from the outside of the recording medium 30.

Here, “plane” means a conceptual model for explaining overlaying procedures of the primary video, secondary video, PG, IG, and text subtitles. In accordance with the present invention, the plane model enables the primary video, secondary video, PG, IG, and text subtitles to be independently controlled. In accordance with the present invention, data supplied from the primary video decoder 730a is reproduced on the primary video plane 740a. Data supplied from the secondary video decoder 730b is reproduced on the secondary video plane 740b. Referring to FIG. 7B, the secondary video plane 740b according to the present invention is superimposed on the primary video plane 740a. The secondary video plane 740a is adjusted in accordance with size and position information included in the metadata for managing reproduction of the secondary video such that the secondary video plane 740b is combined with the primary video plane 740a on the display 20 in the form of a single image. The presentation graphics plane 740c described above with reference to FIG. 7A is superimposed on the secondary video plane 740b. The interactive graphics plane 740d is superimposed on the presentation graphics plane 740c. The presentation graphics plane 740c and interactive graphics plane 740d are combined together on the display 20 in the form of a single image, so that they are supplied to the user through the display 20.

FIG. 9 is a schematic diagram for conceptual understanding of ‘luma-keying’ according to an embodiment of the present invention.

As a method for diversely implementing contents, the present invention provides a reproduction method in which particular pixels on the secondary video plane are processed to become transparent, namely, ‘keyed out’. The keying-out can be implemented by applying ‘luma-keying’ to the secondary video. Originally, ‘luma-keying’ is used to display a still image on a video in an overlapped state, like as the title of a moving picture which is displayed on the moving picture in the form of a still image during the display of the moving picture. In the present invention, the above-described ‘luma-keying’ is intended to be applied to the secondary video reproduced simultaneously with the primary video.

Referring to FIG. 9, when a secondary video plane is superimposed on a primary video plane, the part of a primary video overlapped with the secondary video plane cannot be viewed by the user (910). For example, during reproduction of a primary video which is a main moving image such as a movie or documentary, the comments of the director or episode associated with the shooting procedure may be displayed on the primary video plane, as a secondary video. In this case, the part of the primary video overlapped with the secondary video plane, to which the secondary video is output, is hidden by the secondary video plane (910). When a part of the secondary video, for example, a background part of the secondary video, is processed to become transparent by an application of ‘luma-keying’ thereto in accordance with the present invention, the part of the primary video overlapped with the secondary video plane can be viewed through the transparent part of the secondary video (920). Hereinafter, the ‘luma-keying’ application method will be described in detail with reference to FIG. 9.

For example, the secondary video may include video parts respectively corresponding to a director 910a who explains the primary video, and a background 910b surrounding the director 9 10a. Also, the pixels constituting the secondary video may have different luminance values, respectively. When the director 910a is a main subject to be presented in the secondary video, there may be a need to process the background 910b such that the background 910b becomes transparent, in order to enable the primary video to be viewed through the transparent background 910b. In this case, since the pixels forming one picture may have different luminance values, respectively, a reference luminance for distinguishing the director 910a and background 910b from each other is set. The pixels having luminance values higher than or lower than the reference luminance value are processed to become transparent. For example, when the luminance of the pixels ranges from ‘0’ to ‘255’, and the most bright one of the pixels constituting the background 910b has a luminance value of ‘15’, the reference luminance may be set to the luminance value of ‘15’, and the pixels having luminance values ranging from ‘0’ to ‘15’ may then be processed to become transparent. In this case, the pixels constituting the background 910b become transparent. As a result, the primary video is viewed through the transparent background 920b. At this time, the director 910a is output under the condition in which the original transparency values of the pixels of the director 910a are maintained.

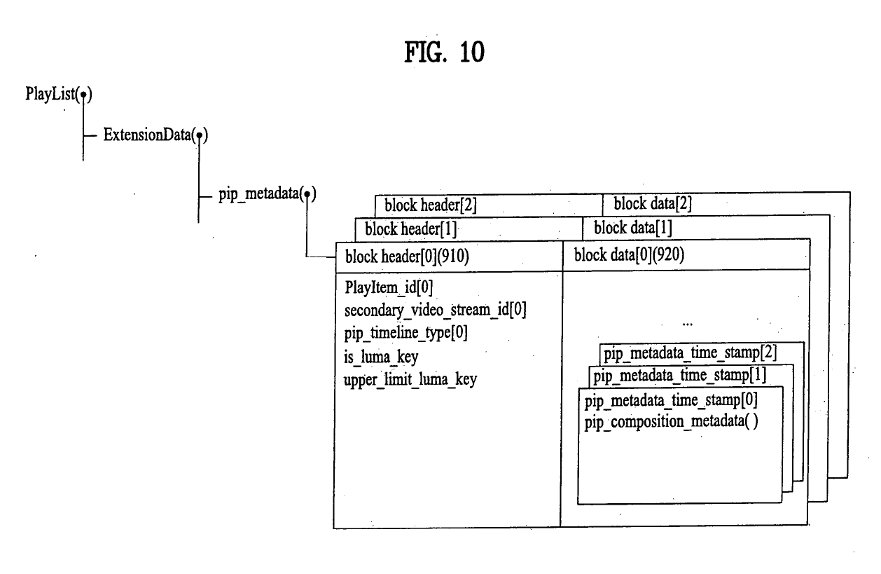

Information as to application of ‘luma-keying’ to the secondary video may be included to the metadata for managing reproduction of the secondary video, so as to be provided to the user. Hereinafter, this will be described with reference to FIG. 10.

FIG. 10 illustrates an exemplary embodiment of the secondary video metadata according to the present invention.

In accordance with the present invention, reproduction of the secondary video is managed using metadata. The metadata includes information about the reproduction time, reproduction size, and reproduction position of the secondary video. In the following description, the metadata will be referred to as “PiP metadata”.

The PiP metadata may be present in a playlist which is a kind of a reproduction management file. FIG. 10 illustrates PiP metadata blocks present in an ‘ExtensionData’ block of a playlist ‘PlayList’ managing reproduction of the primary video. The PiP metadata may include at least one block of a block header ‘block_header[k]’ 910, the number of which is determined depending on the number of metadata block entries stored in PiP metadata blocks, and at least one block of block data ‘block_data[k]’ 920. The block header 910 includes header information of the associated metadata block. The block data 920 includes data information of the associated metadata block. Although the PiP metadata has been described in the embodiment of FIG. 10, as being present in the playlist, the PiP metadata may be present in headers of secondary video streams implementing PiP.

The block header 910 may include a field representing playitem identifying information (hereinafter, referred to as ‘PlayItem_id[k]’), and a field representing secondary video stream identifying information (hereinafter, referred to as ‘secondary video_stream_id[k]’). The information ‘PlayItem_id[k]’ has a value corresponding to a playitem including an STN table in which ‘secondary_video_stream_id’ entries referred to by ‘secondary_video_stream_id[k]’ are listed. The value of ‘PlayItem_id[k] is stored in the playlist block of the playlist file. Preferably, in the PiP metadata, the entries of ‘PlayItem_id’ are sorted in an ascending order with respect to ‘PlayItem_id’ recorded in the PiP metadata. The information ‘secondary_video_stream_id[k]’ is used to identify a sub path, and a secondary video stream to which the associated block data 920 is applied. That is, it is possible to identify the stream entry corresponding to ‘secondary_video stream_id[k]’, in the STN table of ‘PlayItem’ corresponding to ‘PlayItem_id[k]’. Since the stream entry is recorded with the value of the sub path identification information associated with the secondary video, the optical recording/reproducing apparatus 10 can identify the sub path, which is used to reproduce the secondary video, based on the recorded value. The playlist block includes a sub path block.

In accordance with the present invention, the PiP metadata may include information as to application of ‘keying-out’ to the secondary video. The PiP metadata may also include information for specifying pixels to be transparency-processed, namely, to become transparent, in the secondary video. Referring to FIG. 10, when the information representing whether or not ‘keying-out’ has been applied to the secondary video, namely, ‘is_luma_key’, is set to ‘1_{b}’, the information for specifying pixels to be transparency-processed in the secondary video, namely, ‘upper limit_luma_key’, specifies an upper limit of the luminance of the secondary video. For example, when the secondary video is not scaled to full size, the “is_luma_key” indicates whether transparency processing (i.e., the luma-keying function) is applicable to the secondary video. In this case, when the primary video plane 740a and secondary video plane 740b are overlapped with each other, the pixels on the secondary plane 740b, which have luminance values ranging from ‘0’ to ‘upper_limit_luma_key’, are processed to become transparent (namely, ‘transparency-processed’). Thus, the specified pixels exhibit full transparency. Meanwhile, each of the remaining pixels, which have luminance values exceeding ‘upper limit_luma_key’, are maintained at their original opacity. As a result, the part of the primary video positioned behind the opaque pixels cannot be viewed by the user. On the other hand, when the information representing whether or not ‘transparency-processed’ has been applied to the secondary video, namely, ‘is_luma_key’, is set to ‘0_{b}’, all pixels on the secondary video plane exhibit original opacities, respectively. As a result, the part of the primary video positioned behind the secondary video plane cannot be viewed by the user.

The information specifying the pixels to be transparency-processed, may be a lower limit of the luminance of the pixels to be ‘transparency-processed’, namely, ‘lower_limit_luma_key’. In this case, the pixels having luminance values not lower than the lower limit are processed to become transparent. Alternatively, the information specifying the pixels to be transparency-processed, may include both the lower and upper limits of the luminance of the pixels to be transparency-processed, ‘lower_limit_luma_key’and ‘upper_limit_luma_key’. In this case, the pixels having luminance values ranging between the lower and upper limits are processed to become transparent.

Meanwhile, the block header 910 may also include information representing a timeline referred to by the associated PiP metadata (hereinafter, referred to as ‘PiP timeline type ’ pip_timeline_type’). The block data 920 may include time stamp information indicating a point where PiP metadata is positioned (hereinafter, referred to as ‘pip_metadata_time_stamp’). The ‘pip_timeline_type[k]’ is determined in accordance with the type of the timeline referred to by the entries of the above-described ‘pip_metadata_time_stamp[i]’, namely, the type of the timeline referred to by PiP metadata.

The block data 920 may also include at least one block of secondary video composition information (hereinafter, referred to as ‘pip_composition_metadata’), the number of which is determined in accordance with ‘pip_metadata_time stamp[i]’. The i-th ‘pip_composition_metadata’ is secondary video composition information which is effective between ‘pip_metadata time_stamp[i]’ and ‘pip_metadata time_stamp [i+1’.

In detail, the secondary video composition information is information representing the reproduction position and size of the secondary video. The secondary video composition information may include position information of the secondary video, and size information of the secondary video (hereinafter, referred to as ‘pip_scale[i]’). The position information of the secondary video includes horizontal position information of the secondary video (hereinafter, referred to as ‘pip horizontal_position[i]’), and vertical position information of the secondary video (hereinafter, referred to as ‘pip_vertical_position[i]’). The information ‘pip_horizontal_position’ represents a horizontal position of the secondary video displayed on a screen when viewing from an origin of the screen, and the information ‘pip_vertical_position’ represents a vertical position of the secondary video displayed on the screen when viewing from the origin of the screen. The secondary video plane is adjusted in presentation position and size (positioning & scaling), based on the composition information, and is then combined with the primary video plane.

Although the information as to application of ‘luma-keying’ to the secondary video has been described in the case of FIG. 10 as being included in the PiP metadata, the information may be recorded in a clip information file, as separate luma-keying information. Also, this information may be recorded in stream headers as separate information.

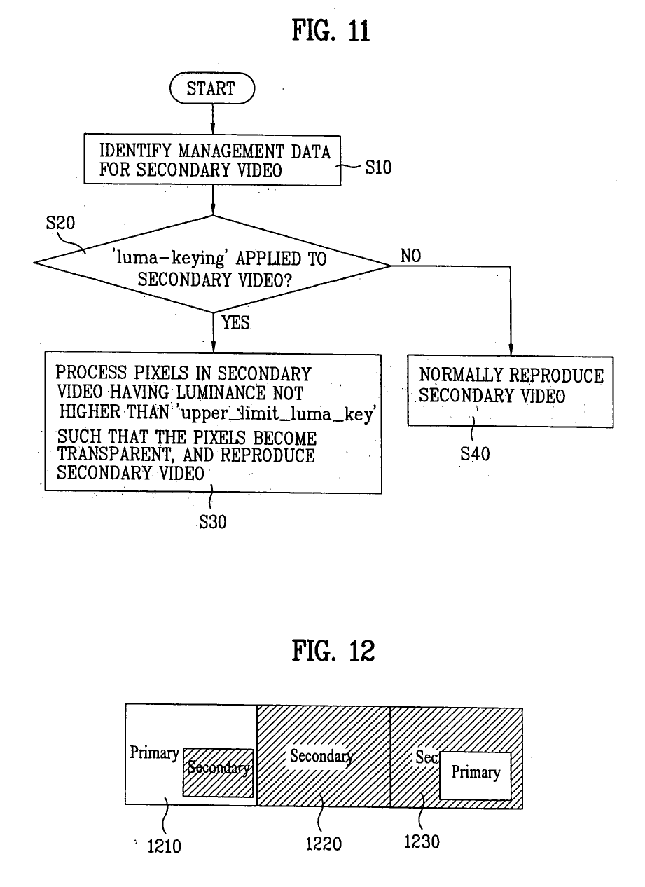

FIG. 11 is a flow chart illustrating an exemplary embodiment of a data reproducing method according to the present invention.

When a playlist file is executed which includes reproduction information as to primary and secondary videos, the controller 12 checks metadata for managing reproduction of the secondary video (S10). The controller 12 then determines whether or not application of ‘luma-keying’ to the secondary video has been set, based on the value of ‘is_luma_key’ included in the metadata as shown in FIG. 10 (S20). When ‘is_luma_key’ has been set to ‘1_{b}’, the pixels in the secondary video, which have luminance values not higher than ‘upper_limit-luma_key’ included in the metadata, are transparency-processed, and are then presented to the user (S40). On the other hand, when ‘is_luma_key’ has been set to ‘0_{b}’, all pixels in the secondary video are presented at original opacities (S30). That is, the pixels are processed to be opaque.

Meanwhile, in place of ‘upper limit_luma_key’, ‘lower_limit_luma_key’ may be included in the metadata. In this case, the controller 12 will transparency-process the pixels having luminance values not lower than ‘lower_limit_luma_key’. Both ‘lower_limit_luma_key’ and ‘upper limit_luma_key’ may be included in the metadata. In this case, the controller 12 will transparency-processed the pixels having luminance values ranging between ‘lower limit_luma_key’ and ‘upper_limit_luma_key’.

Meanwhile, when the secondary video is adjusted in size to have the same size as the primary video, the information as to ‘luma-keying’ included in the metadata may not be applied to the secondary video.

FIG. 12 is a schematic diagram for conceptually understanding a flip of the primary and secondary videos carried out using ‘luma-keying’ in accordance with the present invention.

In the present invention, ‘flip’ means interchange of the sizes of the primary and secondary videos. The position of the primary video flipped on the display 20 may be identical to or different from the position of the secondary video displayed before the flipping. One method of the flipping is to interchange the positions of primary and secondary video planes such that the primary video plane positioned behind the secondary video plane is moved to the position of the secondary video plane, and the secondary video plane is moved to the original position of the primary video plane, and to interchange the sizes of the primary and secondary video planes, simultaneously with the interchange of the positions of the primary and secondary video planes. That is, flipping may be achieved by interchanging the front and back positions of the primary and secondary video planes. However, when ‘luma-keying’ is applied to the secondary video in accordance with the present invention, it is possible to obtain a flip effect without interchanging the front and back positions of the primary and secondary video planes.

Referring to FIG. 12, when the primary and secondary videos are simultaneously reproduced, the secondary video is displayed on the secondary video plane positioned before the primary video plane (1210). Naturally, when the secondary video is adjusted in size to a full size, the primary video cannot be viewed because it is completely hidden by the secondary video (1220). When ‘luma-keying’ is applied to the secondary video in accordance with the present invention, it is possible to process the pixels in the secondary video corresponding to the primary video hidden by the secondary video plane when the secondary video is adjusted in size to the full size, such that the pixels become transparent. In this case, accordingly, the primary video can be viewed through the transparent secondary video (1230). The pixels processed such that they become transparent may be specified using a luminance value for distinguishing the primary and secondary videos from each other, as described above with reference to FIG. 9. The pixels to be transparent may also be specified based on information as to the flipped position and size of the primary video.

As apparent from the above description, in accordance with the recording medium, data reproducing method and apparatus, and data recording method and apparatus of the present invention, it is possible to reproduce primary and secondary videos such that the primary video is viewed through the secondary video. Accordingly, there are advantages in that the content provider can compose more diverse contents, to enable the user to experience more diverse contents.

It will be apparent to those skilled in the art that various modifications and variations can be made in the present invention without departing from the spirit or scope of the inventions. Thus, it is intended that the present invention covers the modifications and variations of this invention.

What is claimed is:

1. A method of managing reproduction of at least one picture-in-picture presentation path, comprising:
reproducing management information for managing reproduction of at least a picture-in-picture presentation path, the management information including luma-keying information on a luma-keying function, the luma-keying function managing transparency of a secondary video stream, and the luma-keying information indicating whether the luma-keying function is applicable to the secondary video stream when the secondary video stream is not scaled to full size, the secondary video stream representing the picture-in-picture presentation path with respect to a primary presentation path represented by a primary video stream; and
reproducing the primary video stream and the secondary video stream based on the management information.

2. The method of claim 1, wherein
the luma-keying information indicates a luma-keying threshold value; and
the reproducing the primary video stream and the secondary video stream step reproduces the secondary video stream such that pixels of the secondary video stream having luminance values less than and equal to the luma-keying threshold are displayed fully transparent if the luma-keying function is applicable to the secondary video data.

3. The method of claim 2, wherein the reproducing the primary video stream and the secondary video stream step reproduces the secondary video stream such that pixels of the secondary video stream having luminance values greater than the luma-keying threshold are displayed fully opaque if the luma-keying function is applicable to the secondary video data.

4. The method of claim 1, wherein
the luma-keying information indicates a luma-keying threshold value; and
the reproducing the primary video stream and the secondary video stream step reproduces the secondary video stream such that pixels of the secondary video stream having luminance values greater than and equal to the luma-keying threshold are displayed fully transparent if the luma-keying function is applicable to the secondary video data.

5. The method of claim 1, wherein
the luma-keying information indicates a luma-keying range; and
the reproducing the primary video stream and the secondary video stream step reproduces the secondary video stream such that pixels of the secondary video stream having luminance values falling within the luma-keying range are displayed fully transparent if the luma-keying function is applicable to the secondary video data.

6. The method of claim 1, wherein the management information includes composition information, and the composition information includes position information indicating a position to display the secondary video stream.

7. The method of claim 6, wherein the position information includes vertical position information indicating a vertical position to display a top left pixel of the secondary video stream on a display of the primary video stream.

8. The method of claim 6, wherein the position information includes horizontal position information indicating a horizontal position to display a top left pixel of the secondary video stream on a display of the primary video stream.

9. The method of claim 8, wherein the position information includes vertical position information indicating a vertical position to display a top left pixel of the secondary video stream on a display of the primary video stream.

10. The method of claim 9, wherein the composition information includes scale information indicating a size to display the secondary video stream.

11. The method of claim 10, wherein the scale information indicates a scale of the display of the secondary video stream with respect to the primary video stream, and the scale information indicates one of no scale, one-half scale, one-quarter scale, one and one-half scale, and full scale.

12. The method of claim 10, wherein the reproducing the primary video stream and the secondary video stream step reproduces the primary and secondary video streams such that the secondary video stream is displayed at a position indicated by the position information and at a size indicated by the scale information.

13. The method of claim 6, wherein the reproducing the primary video stream and the secondary video stream step reproduces the primary and secondary video streams such that the secondary video stream is displayed at a position indicated by the position information.

14. The method of claim 1, wherein the management information includes composition information, the composition information includes scale information indicating a size to display the secondary video stream.

15. The method of claim 1, wherein the reproducing management information step reproduces the luma-keying information as metadata from a playlist recorded in the management area of the recording medium.

16. The method of claim 1, wherein the reproducing the primary video stream and the secondary video stream step decodes the secondary video stream using a different decoder than a decoder used to decode the primary video stream.

17. A method of managing reproduction of at least one picture-in-picture presentation path, comprising:
reproducing management information for managing reproduction of at least a picture-in-picture presentation path, the management information including luma-keying information for a luma-keying function, the luma-keying function managing transparency of a secondary video stream, and the luma-keying function changing if the secondary video stream is scaled to full size, the secondary video stream representing the picture-in-picture presentation path with respect to a primary presentation path represented by a primary video stream; and
reproducing the primary video stream and the secondary video stream based on the management information.

18. A method of managing reproduction of at least one picture-in-picture presentation path, comprising:
reproducing management information for managing reproduction of at least a picture-in-picture presentation path, the management information including luma-keying information on a luma-keying function and composition information, the luma-keying function managing transparency of a secondary video stream, and the composition information including position information indicating a position to display the secondary video stream, the secondary video stream representing the picture-in-picture presentation path with respect to a primary presentation path represented by a primary video stream; and
reproducing the primary video stream and the secondary video stream based on the management information.

19. An apparatus for managing reproduction of at least one picture-in-picture presentation path, comprising:
a driver configured to drive a reproducing device to reproduce data from the recording medium; and
a controller configured to control the driver to reproduce management information for managing reproduction of at least a picture-in-picture presentation path, the management information including luma-keying information on a luma-keying function, the luma-keying function managing transparency of a secondary video stream, and the luma-keying information indicating whether the luma-keying function is applicable to the secondary video stream when the secondary video stream is not scaled to full size, the secondary video stream representing the picture-in-picture presentation path with respect to a primary presentation path represented by a primary video stream; and
the controller configured to control the driver to reproduce the primary video stream and the secondary video stream based on the management information.

20. The apparatus of claim 19, wherein
the luma-keying information indicates a luma-keying threshold value; and
the controller is configured to control reproduction of the primary video stream and the secondary video stream such that pixels of the secondary video stream having luminance values less than and equal to the luma-keying threshold are displayed fully transparent if the luma-keying function is applicable to the secondary video data.

21. The apparatus of claim 20, wherein the controller is configured to control reproduction of the primary video stream and the secondary video stream such that pixels of the secondary video stream having luminance values greater than the luma-keying threshold are displayed fully opaque if the luma-keying function is applicable to the secondary video data.

22. The apparatus of claim 19, wherein
the luma-keying information indicates a luma-keying threshold value; and
the controller is configured to control reproduction of the primary video stream and the secondary video stream such that pixels of the secondary video stream having luminance values greater than and equal to the luma-keying threshold are displayed fully transparent if the luma-keying function is applicable to the secondary video data.

23. The apparatus of claim 19, wherein
the luma-keying information indicates a luma-keying range; and
the controller is configured to control reproduction of the primary video stream and the secondary video stream such that pixels of the secondary video stream having luminance values falling within the luma-keying range are displayed fully transparent if the luma-keying function is applicable to the secondary video data.

24. The apparatus of claim 19, wherein the controller is configured to reproduce the luma-keying information as metadata from a playlist stored in the recording medium.

25. The apparatus of claim 19, further comprising:
a first decoder configured to decode the primary video stream; and
a second decoder configured to decode the secondary video stream.

26. A method of recording a data structure for managing reproduction of at least one picture-in-picture presentation path, comprising:
recording a primary video stream and a secondary video stream in a data area of the recording medium, the primary video stream representing a primary presentation path, the secondary video stream representing a picture-in-picture presentation path with respect to the primary presentation path; and
recording management information for managing reproduction of the picture-in-picture presentation path in a management area of the recording medium, the management information including luma-keying information on a luma-keying function, the luma-keying function managing transparency of the secondary video stream, and the luma-keying information indicating whether the luma-keying function is applicable to the secondary video stream when the secondary video stream is not scaled to full size.

27. The method of claim 26, wherein the luma-keying information indicates a luma-keying threshold value such that, if the luma-keying function is applicable to the secondary video data, pixels of the second video stream having luminance values less than and equal to the luma-keying threshold are displayed fully transparent.

28. The method of claim 26, wherein the luma-keying information indicates a luma-keying threshold value such that, if the luma-keying function is applicable to the secondary video data, pixels of the second video stream having luminance values greater than and equal to the luma-keying threshold are displayed fully transparent.

29. The method of claim 26, wherein the luma-keying information indicates a luma-keying range such that, if the luma-keying function is applicable to the secondary video data, pixels of the second video stream having luminance values falling within the luma-keying range are displayed fully transparent.

30. The method of claim 26, wherein the recording management information step records the luma-keying information as metadata in a playlist in the management area of the recording medium.

31. The method of claim 26, wherein the recording a primary video stream and a secondary video stream step records the primary and secondary video streams such that the primary and secondary video streams can be separated from a data stream reproduced from the recording medium and decoded by separate decoders.

32. An apparatus for recording a data structure for managing reproduction of at least one picture-in-picture presentation path, comprising:
a driver configured to drive a recording device to record data on the recording medium;
a controller configured to control the driver to record a primary video stream and a secondary video stream in a data area of the recording medium, the primary video stream representing a primary presentation path, the secondary video stream representing a picture-in-picture presentation path with respect to the primary presentation path; and
the controller configured to control the driver to record management information for managing reproduction of the picture-in-picture presentation path in a management area of the recording medium, the management information including luma-keying information on a luma-keying function, the luma-keying function managing transparency of the secondary video stream, and the luma-keying information indicating whether the luma-keying function is applicable to the secondary video stream when the secondary video stream is not scaled to full size.

33. The apparatus of claim 32, wherein the luma-keying information indicates a luma-keying threshold value such that, if the luma-keying function is applicable to the secondary video data, pixels of the second video stream having luminance values less than and equal to the luma-keying threshold are displayed fully transparent.

34. The apparatus of claim 32, wherein the luma-keying information indicates a luma-keying threshold value such that, if the luma-keying function is applicable to the secondary video data, pixels of the second video stream having luminance values greater than and equal to the luma-keying threshold are displayed fully transparent.

35. The apparatus of claim 32, wherein the luma-keying information indicates a luma-keying range such that, if the luma-keying function is applicable to the secondary video data, pixels of the second video stream having luminance values falling within the luma-keying range are displayed fully transparent.

36. The apparatus of claim 32, wherein the controller is configured to record the luma-keying information as metadata in a playlist in the management area of the recording medium.

37. The apparatus of claim 32, wherein the controller is configured to control the driver to record the primary video stream and the secondary video stream such that the primary and secondary video streams can be separated from a data stream reproduced from the recording medium and decoded by separate decoders.

38. A recording medium having a data structure for managing reproduction of at least one picture-in-picture presentation path, comprising:
a data area storing a primary video stream and a secondary video stream, the primary video stream representing a primary presentation path, the secondary video stream representing a picture-in-picture presentation path with respect to the primary presentation path; and
a management area storing management information for managing reproduction of the picture-in-picture presentation path, the management information including luma-keying information on a luma-keying function, the luma-keying function managing transparency of the secondary video stream, and the luma-keying information indicating whether the luma-keying function is applicable to the secondary video data when the secondary video stream is not scaled to full size.

39. The recording medium of claim 38, wherein the management information further includes presentation timing information indicating a timing of when to display the secondary video stream with the primary video stream.

40. The recording medium of claim 38, wherein the management information further includes a playitem identifier identifying a playitem of the primary video stream with which the secondary video stream is to be reproduced.

41. The apparatus of claim 19, further comprising:
at least one filter configured to separate at least one of the primary video stream and the secondary video stream from data reproduced from the recording medium.

42. The method of claim 18, wherein the reproducing the primary video stream and the secondary video stream step decodes the secondary video stream using a different decoder than a decoder used to decode the primary video stream.
